(19) United States
(12) Patent Application Publication
(10) Pub. No.: US 2012/0071254 A1
(43) Pub. Date: Mar. 22, 2012

(54) BILLIARD TABLE AND RAIL CLOTH COVERING SYSTEM

(76) Inventor: Thomas Cartwright, Stuart, FL (US)

(21) Appl. No.: 13/158,330

(22) Filed: Jun. 10, 2011

Related U.S. Application Data
(63) Continuation-in-part of application No. 11/747,455, filed on May 11, 2007, now Pat. No. 8,025,583.
(60) Provisional application No. 60/800,223, filed on May 12, 2006.
(60) Provisional application No. 60/882,688, filed on Dec. 29, 2006.

(51) Int. Cl. A63D 15/06; B23P 11/00

(52) U.S. Cl. 473/30; 29/428; 473/31

(57) ABSTRACT

A hook and loop fastening system for attaching a billiard table cloth to a table bed and a rail, a billiard table cloth with template markings for assisting the installer in the correct positing and tensioning of the bed cloth and in the cutting of slits in the cloth for pocket openings (for pocket pool tables) and rail bolt holes, and a rail cloth that incorporates a tract system for attaching the rail cloth on rails to replace conventional feather strips.

### CROSS-REFERENCE TO RELATED APPLICATIONS

This application is a continuation-in-part of co-pending U.S. patent application Ser. No. 11/747,455, filed May 11, 2007 which claims priority from U.S. Provisional Patent Application Ser. No. 60/800,223, filed May 12, 2006 and U.S. Provisional Patent Application Ser. No. 60/882,688, filed Dec. 29, 2006. The disclosures of the aforementioned priority patent applications are herein incorporated by reference.

### FIELD OF THE INVENTION

This invention relates to coverings for billiard tables, pocket pool tables, and other game tables, and the method for installing the same.

### BACKGROUND OF THE INVENTION

Until now billiard tables and pocket pool tables have required a skilled or trained installer/mechanic to put the bed and rail cloth on the table. One of the main skills required is to pull the cloth to the correct tension on as it lies on the table and rail surface. Conventionally, this tensioning step is achieved by securing the cloth to one end or side of the table bed with staples, glue, or feather strips on rails, then pulling the cloth to the opposite end or side. The main consideration is for the amount of stretch the cloth must have to place the cloth under correct tension for the table's playing surfaces, and the amount of stretch may depend on certain factors, such as the type of cloth material. This method is repeated for the two opposite sides and all six rails.

When installing the bed and rail cloth the cloth must be cut at the pocket openings. This is necessary on pocket pool tables, to allow for entry of balls into pockets and for angles on rail ends. Then the cloth is cut into tabs or small sections that are secured to the table by means of staples or glue.

The installer/mechanic performs all of these steps using his or her best judgment as to the correct tension of the cloth on the table when stretching, and as to where the tabs in the cloth must be cut at the pocket openings and rail ends. Determining the correct cloth tension and making accurate cuts require installer expertise, and can consume considerable time.

Therefore, a covering system that aids the installer in applying the appropriate tension to the cloth, and positioning the cuts for the pocket openings and rail ends, is desirable. A method for using such a system is likewise desirable.

### SUMMARY OF THE INVENTION

The invention provides a hook and loop fastening system, such as Velcro® or an adhesive system (such as peel and stick method), for attaching a billiard table cloth to a table bed and a rail. The invention further provides a billiard table cloth with template markings for assisting the installer in the correct positing and tensioning of the bed cloth and in the contouring of the cloth for pocket openings (for pocket pool tables) through various cutting and stitching (sewn) patterns. The invention still further provides a tract system for attaching the cloth on rails that replaces conventional feather strips as well as for preforming the cloth so that on-site cutting and forming is not required.

### BRIEF DESCRIPTION OF DRAWINGS

The present invention is disclosed with reference to the accompanying drawings, wherein:

FIG. 1 is a cross-sectional view of the game table and covering of the prior art;

FIG. 2 is a cross-sectional view of the game table and covering of the present invention, showing the hook and loop fastening system in a first table embodiment;

FIG. 2A is a detail view of the hook and loop fastening system of the present invention;

FIG. 3 is a cross-sectional view of the game table and covering of the present invention, showing the hook and loop fastening system in a second table embodiment;

FIG. 4 is a plan view of the top of the game table covering cloth with template markings according to the present invention;

FIG. 5 is a plan view of the bottom of the game table covering cloth with a pre-attached fastening system on perimeter edge;

FIG. 6 is a cross-sectional view of the rail section and covering of the prior art showing the groove for the conventional feather strip;

FIG. 7 is an isometric view of the rail section and covering of the present invention, showing the tract system and directions of application of the rail cloth covering;

FIG. 8 is a cross-sectional view of the rail and covering of the present invention in a first rail embodiment, showing the tract system opening;

FIG. 9 is a cross-sectional view of the rail and covering of FIG. 8, showing the tract system opening with the rail cloth inserted;

FIG. 10 is a cross-sectional view of the cushion portion of the rail section and covering of FIGS. 9 and 14;

FIG. 11 is an isometric view of the rail and covering of the present invention, showing the ends of the rail cloth preformed and stitched to fit the contour of the rail ends;

FIG. 12 is a cross-sectional view of the cushion portion of the rail and covering of FIGS. 9 and 14, in a second rail attachment embodiment;

FIG. 13 is a cross-sectional view of the cushion portion of the rail and covering of FIGS. 9 and 14, in a third rail attachment embodiment;

FIG. 14 is a cross-sectional view of the rail and covering of the present invention in a second rail embodiment, showing the tract system opening with the inserted enclosure and the rail cloth inserted in the enclosure;

FIG. 15A is a cross-sectional view of the groove portion of a rail and covering of the present invention in the second rail section embodiment, showing the insertion of an enclosure for the tract system into the groove for the conventional feather strip;

FIG. 15B is a cross-sectional view of the groove portion of a rail and covering of the present invention in the second rail section embodiment, showing the attachment of the enclosure for the tract system within the groove for the conventional feather strip;

FIG. 15C is a cross-sectional view of the groove portion of a rail and covering of the present invention in the second rail section embodiment, showing the rail cloth inserted in the tract system as in FIG. 14;

FIG. 16 is a plan view of the game table covering with template markings according to the present invention;

FIG. 17A is a magnified view of a corner of the game table covering cloth of FIG. 4 showing preformed cloth at the pocket opening in the midst of application; and

FIG. 17B is a second magnified view of a corner of the game table covering cloth of FIG. 4 showing preformed cloth at the pocket opening after application of the preformed corner cloth is completed;

FIG. 18 illustrates a prior art contoured corner with a prior art rail cloth having bunching;

FIG. 19 depicts a non-bunching rail cloth of the present invention;

FIG. 20 is another depiction of a non-bunching rail cloth of the invention; and

FIGS. 20 and 22 are depictions of various pairs of rail cloths.

Corresponding reference characters indicate corresponding parts throughout the several views. The examples set out herein illustrate several embodiments of the invention but should not be construed as limiting the scope of the invention in any manner.

### DETAILED DESCRIPTION

The invention provides a system to eliminate the customary guesswork and independent judgment usually required of an installer of a new cloth covering for a billiard or pool table. An installer with only basic skill may use this new cloth covering system, which reduces sharply the labor cost of replacement of the cloth. The system of the present invention provides a new method of securing the cloth to the table using a pre-determined correct tensioning of the stretched cloth, and of preforming the pocket openings with various stitching (sewn) patterns in the cloth. Labor costs for initial installation of the cloth at the time of table production may also be reduced by use of the present invention.

In the present application, the term “game table” will be used to denote any of a billiard table, a pocket pool table, a bumper pool table, or any similar table requiring a level, smooth surface on which a ball may roll and a set of surrounding cushions that have sufficient elasticity to cause a ball rolling on the surface to bounce back away from a cushion on impact.

### Structure Description

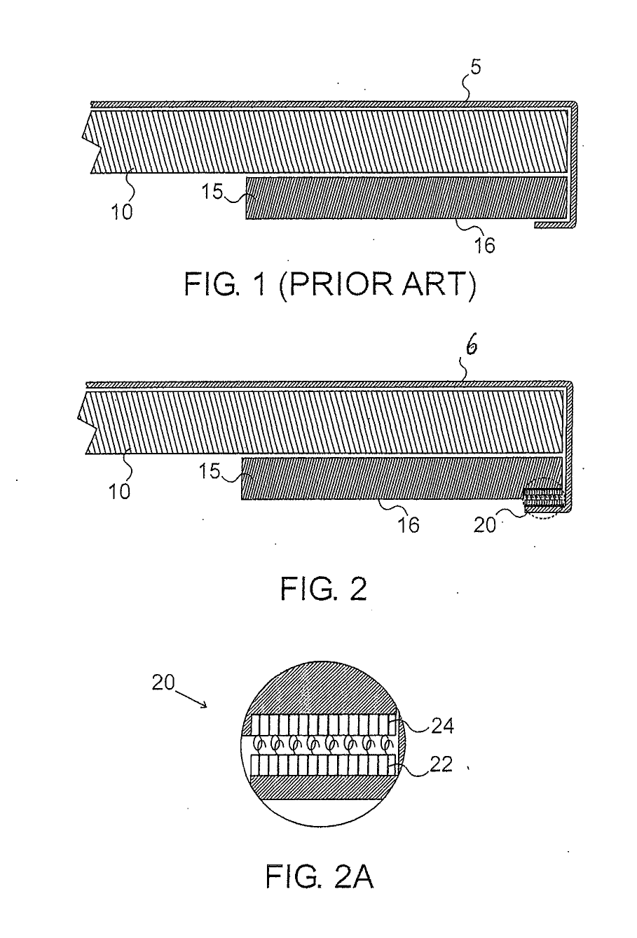

FIG. 1 shows the prior-art conventional arrangement in which a bed cloth 5, which is the cloth covering the playing surface of the table slate 10 and the cushions of a game table, is attached to the underlying flat surface 16 of the table support structure 15.

A first table embodiment of the present invention is shown in FIG. 2 in cross section. The bed cloth 6 is secured to the table support structure 15 by means of a two part (“A & B”) hook and loop fastening system 20, such as a Velcro® system, shown in detail in FIG. 2A. The system has the “A” part 22 pre-attached to the cloth and the complementary “B” part 24 pre-attached to the table. This eliminates the tools and mess associated with methods that require gluing to secure the cloth to the table. A pre-attached no-mess, peel-and-stick glue or adhesive system may also be used. Also, mechanical fasteners, such as staples, may be used to further secure the bed cloth once the bed cloth is in the desired position.

In another embodiment, not shown, the bed cloth is preformed with edges that are contoured to the shape of the pockets. Each pocket includes two pocket points, each of which is located where the curved edge of the pocket meets one of the two connecting table edges. In those embodiments where the bed cloth is preformed, the bed cloth includes a large horizontal surface that covers the playing surface and vertical surfaces that fit securely over the vertical surfaces of the six pockets. The bed cloth is preformed to fit snuggly on the table once each of the six vertical surfaces of the bed cloth are so attached. Any excess bed cloth that is located between each of the pockets can be adhered to the underside of the table. One means for adhering the bed cloth to the underside of the table is to use the aforementioned hook and loop fastening system 20. Another means for adhering excess bed cloth to the understanding of the table is to use a track system similar to the rail cloth track system described elsewhere in this application. In such an embodiment, the length of bed cloth that is between each of the pockets is equipped with a tract shaft (similar to track shaft 35 or simply folded and sewn to thicken the edge of the bed cloth). This shaft or thickened edge fits into a track groove (similar to track groove 46 used for the rail cloth) that is disposed under the playing surface. Since there are six lengths of cloth between each of the pockets, there are also six shafts that fit into grooves under the table. The details of the bed cloth attachment system are otherwise similar to those of the rail cloth attachment system.

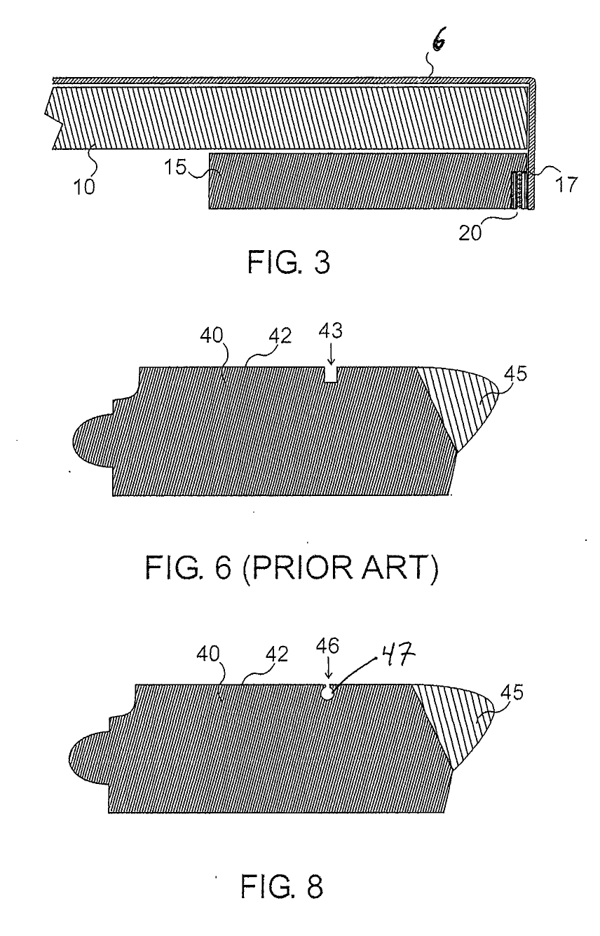

In its first table embodiment in FIG. 2 the “B” part 24 of the hook and loop fastening system 20 is pre-attached to the horizontal face 16 of the table support structure 15, where it engages with the “A” part 22 of the hook and loop fastening system. In a second table embodiment, shown in FIG. 3, the “B” part 24 of the invention is pre-attached to the vertical face 17 of the table support structure 15, where it engages with the “A” part 22 of the hook and loop fastening system.

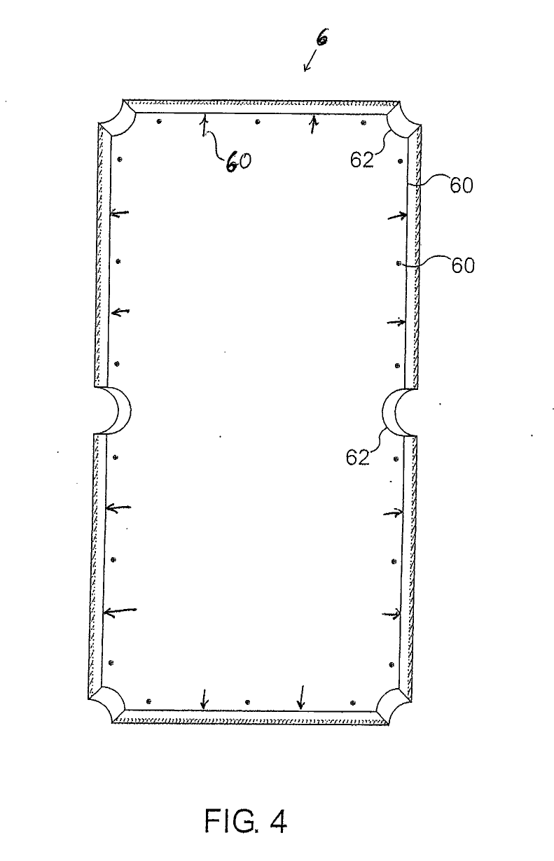

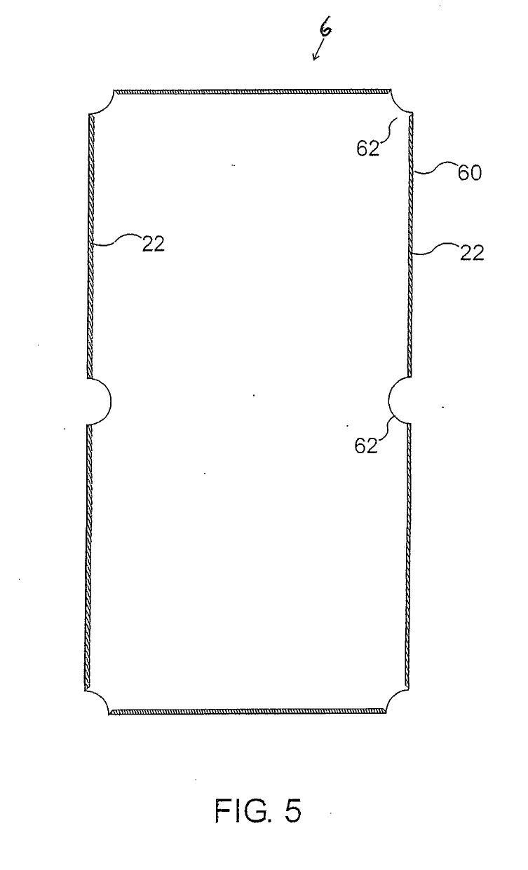

The table bed cloth of the present invention is shown in plan view from the top in FIG. 4, and in plan view from the bottom in FIG. 5. The invention's preformed pocket openings 62 are shown in FIG. 4. The “A” part 22 is shown in FIG. 5.

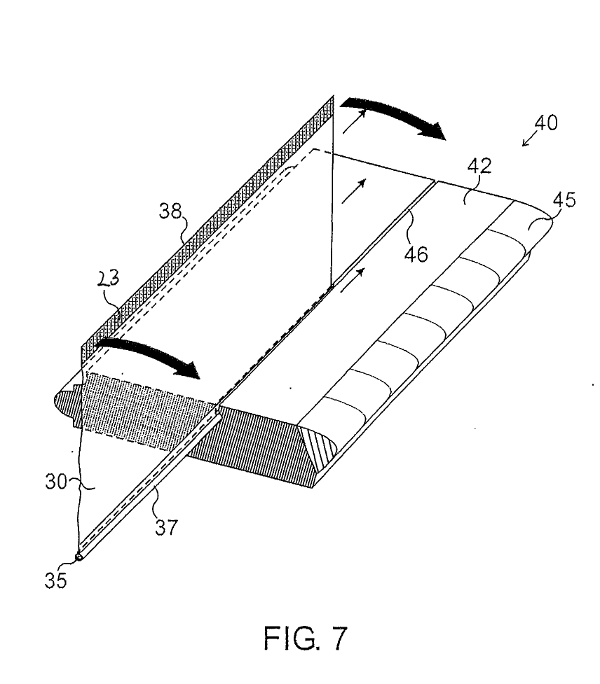

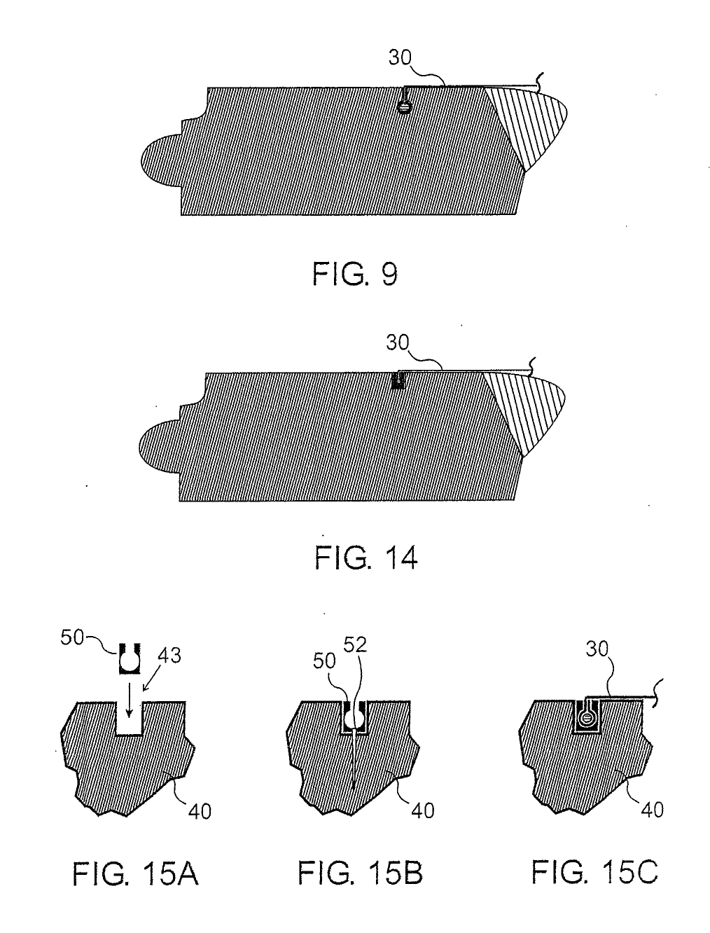

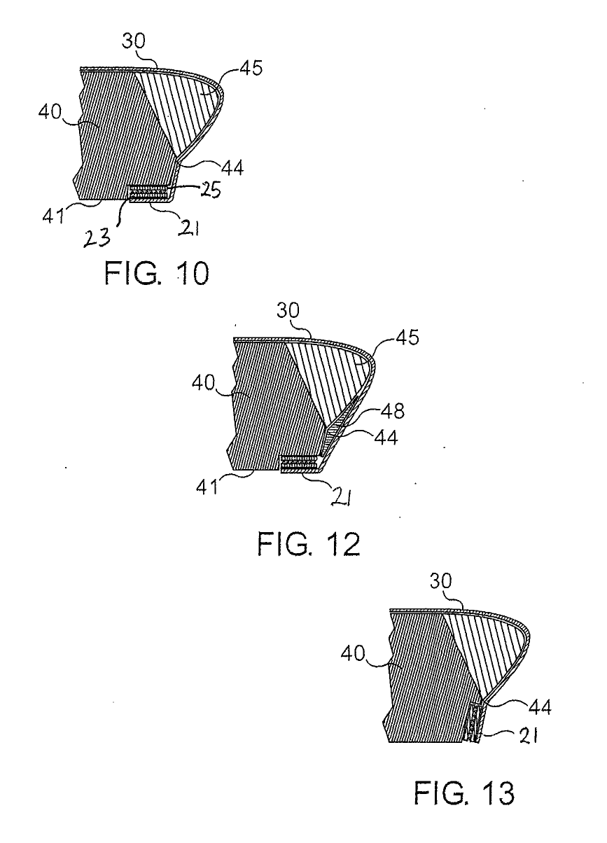

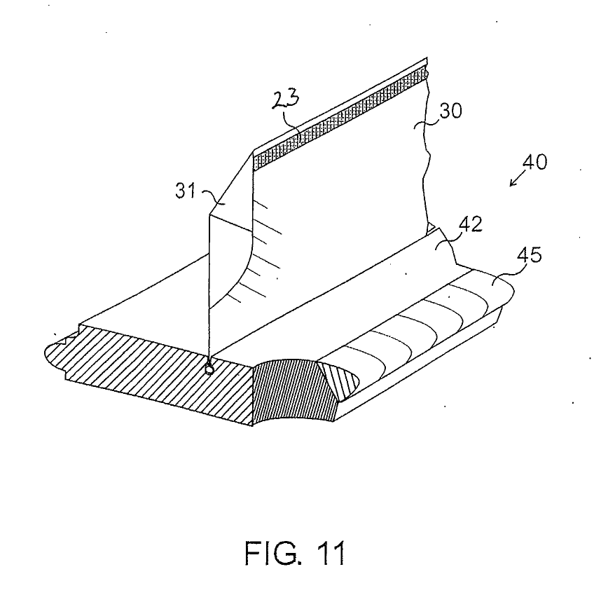

FIG. 6 shows a cross-section of a conventional table rail 40, with cushion 45 and a groove 43 on the rail top surface 42, which holds one edge of the rail cloth in place using a feather strip method well-known in the art. As shown isometrically in FIG. 7 and in cross section in FIGS. 8 and 9, the invention replaces the prior-art feather strip method shown in FIG. 6 with a tract system. The rail cloth 30 slides through a tract system groove 46 extending between a tract retaining hole 47 and the rail top surface 42. In a first rail attachment embodiment shown in FIG. 10, the rail cloth 30 attaches to the underside 41 of the rail 40 by means of a hook and loop fastening system 21, such as a Velcro® system, with complementary strips 23 and 25. The ends 31 of the rail cloths 30 are preformed and stitched (sewn) to fit the contour of the rail ends, as shown in FIG. 11.

Prior art rails are generally not level over the length of the table due to bunching of rail cloth under the rails near the pockets. FIG. 18 illustrates the bottom view of a prior art rail 40 with rail cloth 76. The rail cloth 76 of FIG. 18 includes both single layer 70 at the center of the rail and bunching 72 near the contoured ends of the rail. During installation, the rail cloth 76 is stretched into position, stapled with staples 78, and then re-positioned and re-stabled until the rail 40 is covered. In other words, the prior art rail cloth is secured to the rail during assembly of the table and is not preformed.

Bunching 72 is produced when the rail cloth 76 is wrapped about the contoured ends 74 of a rail that are proximate to the pockets. Since prior art rail cloth 76 is not preformed to fit the contour the rail ends 74, it is necessary to fold the rail cloth about the contoured end 74, thereby resulting in bunching 72. When the rail is thereafter disposed on the periphery of a table bed, each bunch causes the rail to be raised near the pockets (where the bunching occurs) but lowered near the center (where a single layer of rail cloth is present). This results in the rail being uneven/unlevel over the length of the table. Since the folding pattern is unique to a given table, subtle variations in the rails that are specific to a particular table result. In the field of professional pool, wherein the skill level is extraordinarily high, each player must learn the nuances of each individual pool table and quickly adjust for these variations in the rail system of each particular table.

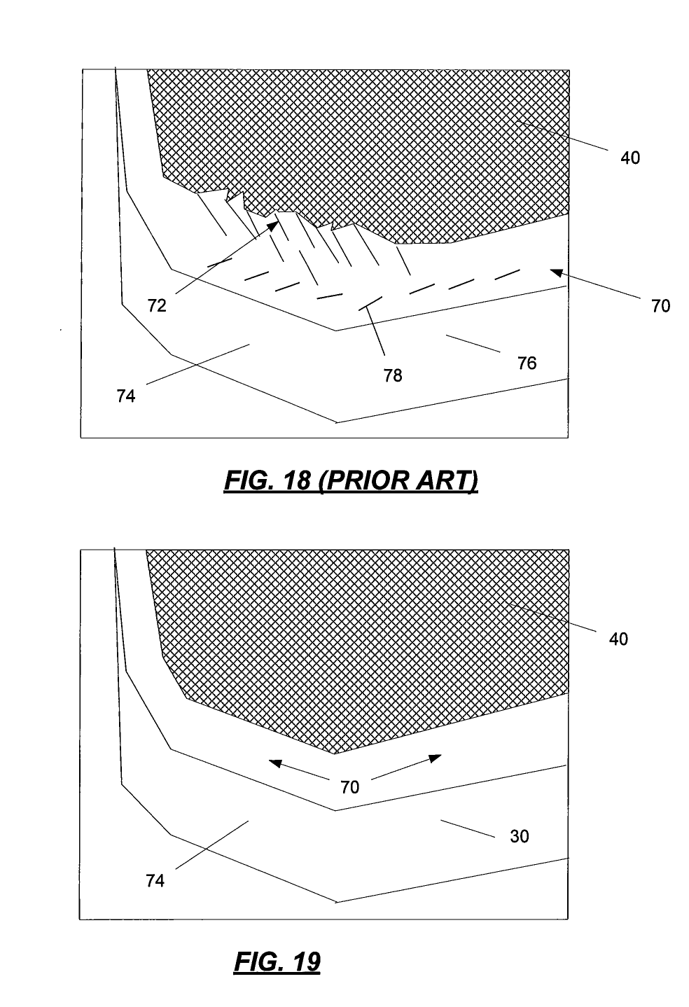

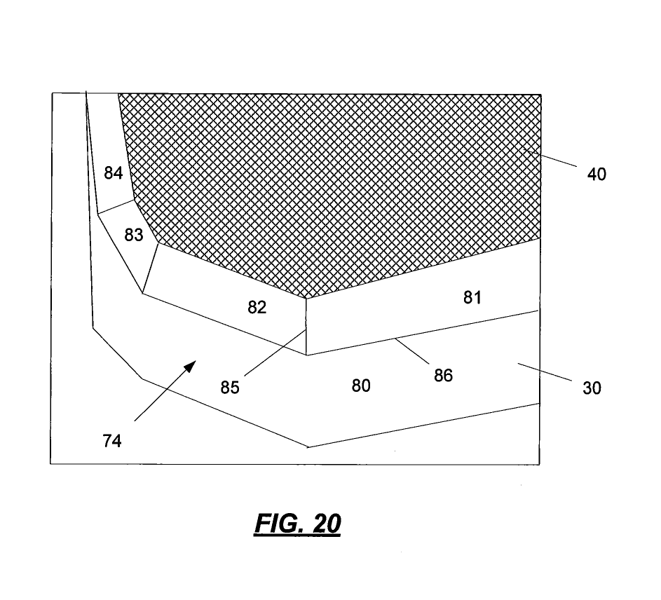

FIG. 19 shows a bottom view of preformed rail cloth 30 that has been stitched (sewn) to fit the contour of the rail ends 74. The contour of the end of the rail cloth 30 corresponds to the contour of the ends of the rail 74. Unlike prior art rail cloth 76, rail cloth 30 has only a single layer 70 of rail cloth and does not cause the rail cloth to bunch. One configuration for achieving this result is depicted in FIG. 20.

FIG. 20 depicts preformed rail cloth 30 that includes large section 80 stretched about the vertical surface of rail 40. Preformed rail cloth 30 also includes a plurality of smaller sections 81-84 stretched on the horizontal undersurface of rail 40. Vertical section 80 and under sections 81-84 are separated from one another by fold-line 86 which is formed by an edge of the underlying. Each section 81-82 is separated from the adjacent under sections by lines 85. These lines and the overall form of preformed rail cloth 30 is established prior to assembly of the table to match the contoured ends 74 at the termini of the rails. In one embodiment, lines 85 represent stitching lines from a sewing operation. In another embodiment, the lines are cut lines and adhesive is used. This is in contrast with prior art rail cloths which are not performed. When the rail 40 is disposed on the bed cloth 6, sections 81-84 contact the bed cloth. Since sections 84-81 are a single layer of rail cloth thick and do not bunch, the resulting rail is level over its entire length.

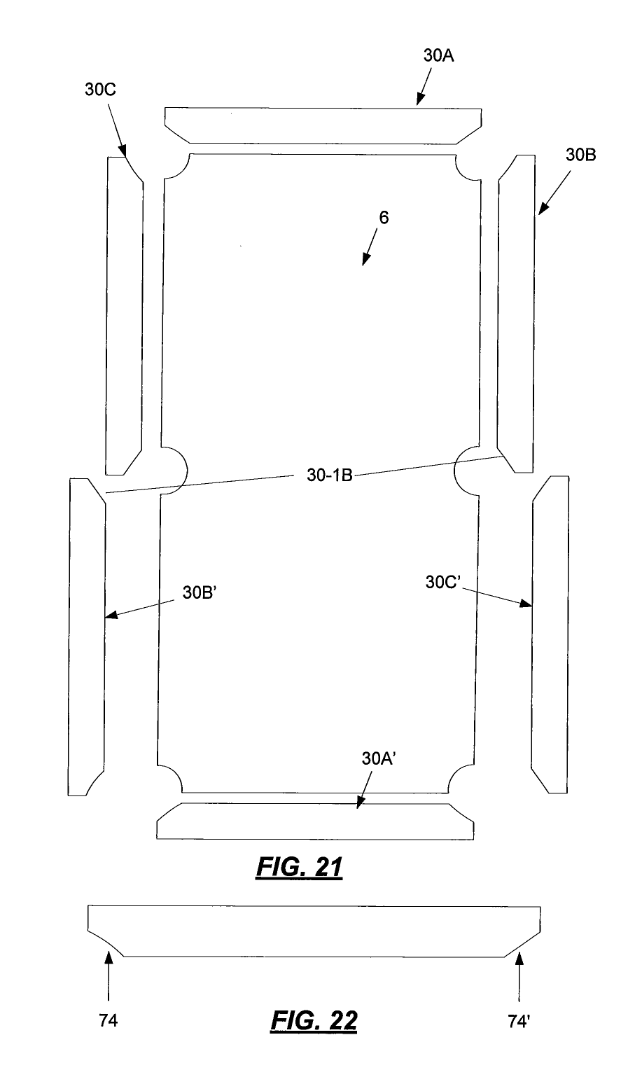

FIG. 21 depicts three pairs of rail cloths that includes first pair 30A, 30A′, second pair 30B, 30B′, and third pair 30C, 30C′. As shown schematically in FIG. 22, each rail cloth includes two preformed ends 74, 74′ which may be dissimilar. These ends are contoured to match the contoured ends of corresponding rails to prevent bunching. In FIG. 21, each of the rails is positioned proximate to the final position of the corresponding rail 40 (not shown) to better illustrate the various rail cloths. In certain embodiments, it is advantageous to make the ends of each pair dissimilar. In other embodiments, the ends of the rail cloths are mirror symmetrical. By way of illustration, the first pair of rail cloths 30A, 30A′ have ends configured to he proximate a corner pocket. Accordingly, the ends of the first pair of rail cloths are, in one embodiment, mirror symmetrical. Second pair of rail cloths 30B, 30B′ have dissimilar ends, the right-hand end being configured to be proximate a corner pocket while the left-hand end is configured to be proximate a center pocket. Similarly, rail cloths 30C, 30C′ have similar ends, the right-hand end being configured to be proximate a center pocket while the left-hand end is configured to be proximate a corner pocket.

FIG. 7 shows a portion of the rail cloth 30 during insertion in the tract system groove 46 of the rail section 40. A loop of one edge 37 of rail cloth 30 is sewn around a tract shaft 35 or simply folded and sewn to thicken the edge 37. One strip 23 of the hook and loop fastening system 20 is anchored to the opposite edge 38 of the rail cloth 30. The edge 37 of the rail cloth 30 is then slid into tract groove 46 and the tract retaining hole 47. The tract groove 46 is formed so as to allow only the thickness of rail cloth 30 to pass through the groove's opening to the top surface 42 of rail 40. Once the rail cloth 30 is fully inserted in rail section 40, rail cloth 30 is stretched over cushion 45 and fastened to rail 40 beneath cushion 45. In one embodiment, the tract groove 46 has an opening with a width less than twice the thickness of the rail cloth. In this fashion, a folded edge of the rail cloth, which has a thickness that is equal to or greater than twice the thickness of the unfolded rail cloth by virtue of its folding, is retained within the tract groove 46.

Since the cushion 45 protrudes from the rail 40 to leave a concavity running the length of the rail 40 beneath the cushion 45, the rail cloth 30 is affixed to the rail face 44 beneath the cushion 45 either by the adhesive force of the hook and loop fastening system 20 or by a conventional means such as tacking or stapling once the hook and loop fastening system 20 has been correctly positioned. Alternatively, as shown in FIG. 12, an insert 48 may be placed beneath the cushion 45 so as to support the rail cloth 30 between the cushion 45 and the base of the rail 40. In a second rail attachment embodiment shown in FIG. 13, the rail cloth 30 attaches to the rail face 44 beneath the cushion.

An embodiment for upgrading a conventional rail configured for cooperation with a feather strip is shown in FIGS. 14 and 15A. in this embodiment, the invention provides an insertable track 50 to be placed inside the groove 43 for the feather strip of a conventional rail. The insertable track 50 is installed in the feather strip groove 43 by a press fit, using adhesive, using tacks, using other conventional means, or combinations thereof. The tacks 52 are shown in FIG. 15B. The invention's tract system uses the installed track with the invention's rail cloth 30 as shown in FIG. 15C.

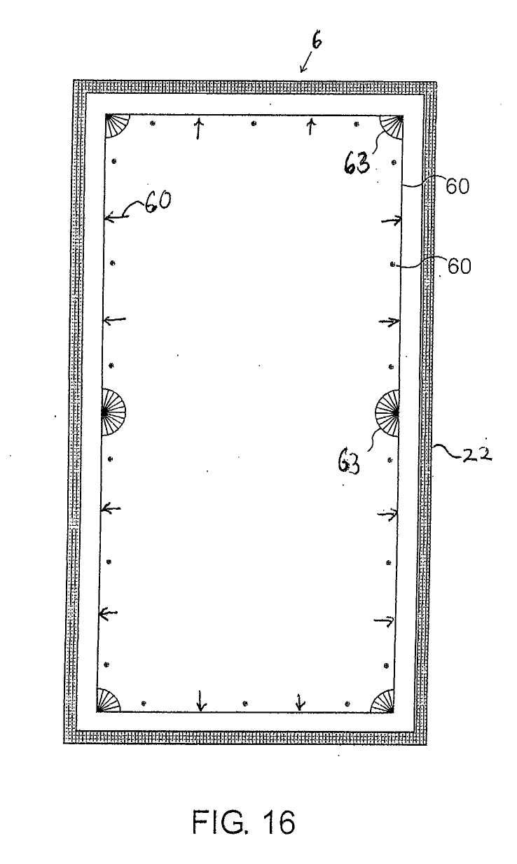

The invention's bed cloth 6 is templated with line markings 60 and/or written instructions on the surface to show the correct position for the cloth on both ends and sides for proper tensioning of the bed cloth when secured (see FIG. 16). The template markings 60 are positioned on the cloth according to the type of cloth and its elasticity, so that when the cloth is drawn to the required tension, template markings 60 are aligned with the table's edges. The template markings 60 may also indicate the location of rail bolt holes.

The installer can now rely on the pre-marked lines to pull or stretch the bed cloth 6 to the right position and tension. The lines 60 on the cloth 6 are pulled to the edges of the table bed and then secured by the hook and loop fastening system 20.

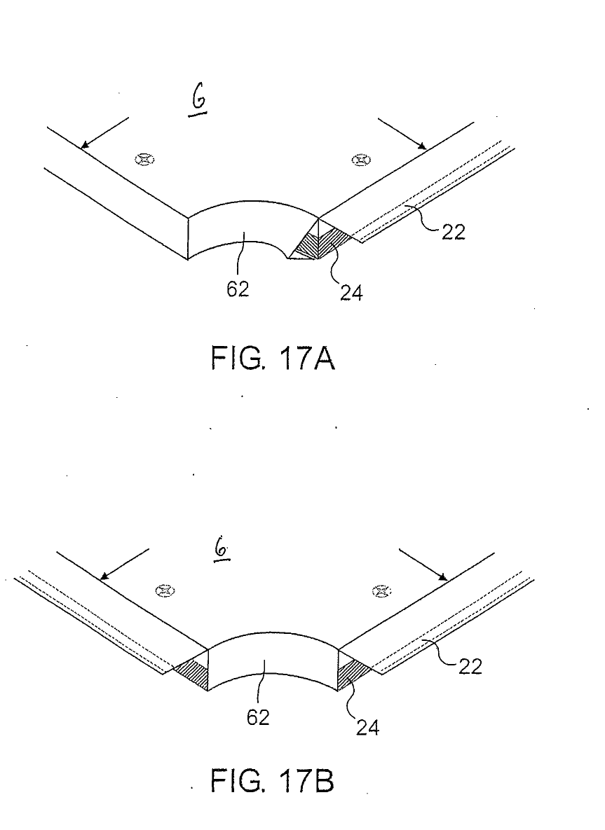

In a particular pocket-forming embodiment shown in FIGS. 17A and 17B, the invention's bed cloth is produced with preformed openings for pockets that are stitched (sewn) with various patterns to accommodate the pocket openings. The patterns coincide with the type of pocket. A contoured cloth 62 is sewn onto the bed cloth such that the stitch line is below the playing surface when the bed cloth is installed. The hook and loop fastener strip 22 is pre-attached to the bottom of the contoured cloth 62. In some cases, table pockets vary so some cutting of the contoured cloth 62 may be needed for a proper installation.

In an alternative pocket-forming embodiment, tabs 63 are cut in the cloth 6 at the pocket openings using lines templated and pre-marked on the cloth as in FIG. 16 to show the position where the cloth 6 needs to be cut at pocket openings. The cloth 6 may be pre-cut and have the hook and loop fastening system pre-attached to the underside of the cloth at the pockets.

In an alternative securing embodiment, the templating system can be used with the existing staples or glue securing method, or an adhesive system (such as peel and stick method), as opposed to using the hook and loop fastening system.

### Process Description

The invention's steps for placing or replacing the cloths of a game table begin with the fabrication of a bed cloth with template markings, pocket cuts, and a bed cloth edge fastening system, and the fabrication of a set of rail cloths, one for each rail section. Both the bed cloth and all rail cloths are marked using templates to show how far each cloth should be stretched to obtain the proper tension in the cloth for use of the table. Each rail cloth is fabricated with a rail cloth edge fastening system along one edge, and a tract edge fastening system along the opposite edge.

To install the cloths, the installer removes all rail sections from the game table to gain access to the bed cloth and the rail cloths for placement. The installer then stretches the bed cloth over the table bed using the bed cloth edge fastening system, and stretches each rail cloth over the rail section's cushion, anchoring the rail cloth's outer edge to the top of the rail using the tract edge fastening system, and anchoring the rail cloth's inner edge under the rail cushion using the rail cloth edge fastening system. The installer completes the job by replacing the rail sections on the game table.

The invention uses a hook and loop edge fastening system in a first fastening embodiment of its bed cloth and rail cloth edge fastening system, anchoring the hook and loop system to the edge of the cloth. In a second fastening embodiment, the invention uses a conventional glue or stapling method of fastening.

To make template markings and pocket cuts in the bed cloth, the invention includes cutting a bed cloth to a size sufficient to anchor said bed cloth to the underside of a game table, stretching the bed cloth over a template of a game table, and marking the bed cloth with the locations of the edges and the pockets of the template. The invention also allows for, when needed, cutting the bed cloth radially from the centers of the pocket locations of the table template to the edges of the pocket locations of the table template, allowing the cloth to hang down into the pockets to provide attachment for the pockets themselves.

To make template markings in a rail cloth, the invention includes cutting a rail cloth to a size sufficient to anchor the rail cloth to the top of a rail section and the underside of the rail section, stretching the rail cloth over a template of a game table rail, anchoring the rail cloth to the template, and marking the rail cloth with the location of the edge of the template.

To construct a tract edge fastening system, the invention includes cutting a retaining groove in each rail section substantially parallel to the rail cushion, cutting a rail cloth to a size sufficient to anchor the rail cloth to the rail section, fabricating a closed loop along the first edge of the rail cloth substantially parallel to the rail section to contain a tract shaft, and inserting the tract shaft in the closed loop. Making the retaining groove includes drilling a tract retaining hole in each rail section substantially parallel to the rail cushion and the full length of the rail section and cutting a tract retaining groove from the rail top through to the tract retaining hole. To hold the edge of the rail cloth, the tract retaining groove has a width smaller than the diameter of the tract shaft.

In an alternative tract edge fastening system embodiment better suited to conversion of conventional rail sections for the invention's use, the invention provides a tract retainer, of a size sufficient to contain and hold the tract shaft and the closed loop of the rail cloth, to be installed in the feather strip groove of each conventional rail section substantially parallel to the rail cushion. The installer anchors the tract retainer in the rail feather strip groove.

The bed cloth is fastened to the table using the invention's hook and loop fastening strip anchored to the table's horizontal underside or anchored to the outer vertical face of the table's underside. The rail cloth is fastened to the rail by anchoring a rail cloth hook and loop fastening strip to the edge of the rail cloth opposite the edge carrying the tract system, and fastening the fastening strip to its counterpart fastening strip on either the underside of the rail section or the inner face of the rail section below the cushion. In a particular embodiment, the hook and loop fastening strips are pre-attached to the edge of the cloth and the underside of the table.

The invention's methods for the installation of cloth coverings for game tables greatly simplifies the installation process. The simplification allows for more installations within a given time period, thereby raising installer productivity. The simplification also enables installation by less-skilled individuals, thereby reducing installation labor cost. Finally, and most importantly, the simplification provides a level of accuracy not yet attained in a consistent repetitive manner with the use of conventional methods.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A method for placing cloth on a game table comprising the steps of:
providing a game table having a table bed with a rectangular periphery and a plurality of pockets in the periphery;
providing a plurality of elongated rails for being disposed on the periphery, each rail having contoured ends for being disposed proximate the pockets;
stretching a bed cloth over the table bed and securing the bed cloth thereto;
providing a plurality of preformed rail cloths whose preformed ends match the contoured ends of the rails;
stretching each of the preformed rail cloths over each of the rails such that the preformed ends of the rail cloth fits the contoured ends of the rail;
disposing the rails on the periphery of the table bed after the rail cloths have been stretched over each of the rails such that each rail extends from one pocket to another pocket thereby placing the contoured ends of each rail proximate one of the pockets.

2. The method as recited in claim 1, wherein the step of stretching each of the preformed rail cloths stretches each cloth such that there is a single layer of rail cloth about each rail.

3. The method as recited in claim 1, wherein the step of stretching each of the preformed rail cloths stretches each cloth such that the rail cloth does not bunch.

4. A method for placing cloth on a game table comprising the steps of:
providing a game table having a table bed with a rectangular periphery and a plurality of pockets in the periphery;
providing six elongated rails for being disposed on the periphery, each rail having contoured ends for being disposed proximate the pockets;
stretching a bed cloth over the table bed and securing the bed cloth thereto;
providing three pairs of preformed rail cloths, each pair being different from the other two pairs in that each pair has different preformed ends that match the contoured ends of a corresponding pair of rails selected from the six elongated rails;
stretching each of the preformed rail cloths over the corresponding rails such that the preformed ends of the rail cloth fits the contoured ends of the rail;
disposing the rails on the periphery of the table bed after the rail cloths have been stretched over each of the rails such that each rail extends from one pocket to another pocket thereby placing the contoured ends of each rail proximate one of the pockets.

5. The method as recited in claim 4, wherein each of the preformed rail cloths includes a plurality of sections that, during the step of stretching each of the preformed rail cloths, are disposed on an undersurface of the corresponding rails such that the plurality of sections does not overlap.

6. The method as recited in claim 4, wherein each pair of the three pairs of preformed rail cloths includes a first pair including a first rail cloth with similar ends; a second pair including a second rail cloth with dissimilar ends and a third pair including a third rail cloth with dissimilar ends.

7. The method as recited in claim 6, wherein the first pair includes a fourth rail cloth that is substantially identical to the first rail cloth.

8. The method as recited in claim 7, wherein the second pair includes a fifth rail cloth that is substantially identical to the second rail cloth and the third pair includes a sixth rail cloth that is substantially identical to the third rail cloth.

9. A game table comprising:
a table bed with a rectangular periphery and a plurality of pockets in the periphery;
a plurality of elongated rails disposed on the periphery, each rail extending from one pocket to another pocket with contoured ends proximate the pockets;
a bed cloth stretched over the table bed and secured thereto;
a plurality of preformed rail cloths, each having preformed ends that match the contoured ends of a corresponding rail selected from the plurality of rails, the preformed rail cloths being stretched over the corresponding rails such that the preformed ends of the rail cloth fits the contoured ends of the rail.

10. The game table as recited in claim 9, wherein the plurality of elongated rails consists of six elongated rails.

11. The game table as recited in claim 9, wherein the plurality of preformed rail cloths consists of three pairs of preformed rail cloths, each pair being different from the other two pairs in that each pair has different preformed ends.

12. The game table as recited in claim 9, wherein the preformed rail cloths are stretched over the corresponding rails such that the rail cloths are a single layer thick.

13. The game table as recited in claim 9, wherein the preformed rail cloths are stretched over the corresponding rails such that the rail cloth does not bunch.
